(19) United States
(12) Patent Application Publication
(10) Pub. No.: US 2026/0324702 A1
(43) Pub. Date: Oct. 22, 2026

(54) FURNACE BODY FOR A DRUM ROASTER FOR ROASTING BEANS, DRUM ROASTER, AND OPERATING METHOD

(71) Applicant: PROBAT SE, EMMERICH (DE)

(72) Inventors: THOMAS KOZIOROWSKI, MUELHEIM AN DER RUHR (DE); DIETMAR WISSEN, REES (DE); MICHAEL DAMEN, EMMERICH AM RHEIN (DE)

(73) Assignee: PROBAT SE, EMMERICH (DE)

(21) Appl. No.: 19/110,438

(22) PCT Filed: Sep. 19, 2023
(86) PCT No.: PCT/EP2023/075763

§ 371 Date: Mar. 11, 2025

(30) Foreign Application Priority Data
Sep. 20, 2022 (DE) 10 2022 124 087.8

(51) Int. Cl. A23N 12/10; A23L 5/10; A23N 12/12; F27B 7/22; F27B 7/34; F27B 7/36; G01J 1/42

(52) U.S. Cl. CPC A23N 12/10; A23L 5/15; A23N 12/125; F27B 7/22; F27B 7/34; F27B 7/36; G01J 1/429

(57) ABSTRACT

A furnace body for a drum roaster. The drum roaster is a part of a combustion arrangement. The combustion arrangement is for a combustion gas for heating a supply air. At least one combustion flame is guided in the combustion arrangement. A hydrogen-air mixture is provided as the combustion gas. The furnace body includes a hollow cylinder arrangement which is arranged to enclose a combustion chamber. The hollow cylinder arrangement has a first base surface, a second base surface, and at least one single-walled hollow cylinder. The second base surface is open to discharge heating air. The combustion arrangement is arranged in the hollow cylinder arrangement. The combustion arrangement has a burner pad and an ignition device. A combustion gas supply is fluidically connected to the first base surface.

### CROSS REFERENCE TO PRIOR APPLICATIONS

This application is a U.S. National Phase application under 35 U.S.C. § 371 of International Application No. PCT/EP2023/075763, filed on Sep. 19, 2023 and which claims benefit to German Patent Application No. 10 2022 124 087.8, filed on Sep. 20, 2022. The International Application was published in German on Mar. 28, 2024 as WO 2024/061881 A1 under PCT Article 21(2).

### FIELD

The present invention relates to furnace body for a drum roaster for roasting beans, to a drum roaster, and to a method of operation. The present invention provides a furnace body for a drum roaster, which is part of a combustion arrangement for a combustion gas for heating supply air and in which at least one combustion flame is guided. The present invention also provides a drum roaster for roasting beans, with a housing arrangement in which a roasting drum for receiving the beans is rotatably supported, wherein a drive is provided for rotating the roasting drum and a heating assembly is provided for heating the beans at least via heating air, wherein the heating assembly comprises at least one combustion assembly, which is arranged upstream of the roasting drum, as viewed in the flow direction of the heating air, for a combustion gas for heating supply air, with a furnace body in which at least one combustion flame is guided, and at least one suction fan, which is arranged downstream of the roasting drum as viewed in the direction of flow of the heating air, for extracting the heating air from the roasting drum. The present invention also provides a method for operating a drum roaster.

### BACKGROUND

Drum roasters are well known from the prior art and are in particular used as so-called small, shop or in-store roasters in smaller roasting plants or shops or cafés. An example thereof is the drum roaster of EP 2 689 677 A1 which describes a combustion arrangement for a combustion gas, in this case natural gas, the heating air generated being drawn into the roasting drum by a suction fan to thus roast the beans in the roasting drum. Rising energy prices and the shortage of fossil energy sources require a reconsideration of how to generate heating air and the use of alternative energy sources. It is noted that the use of hydrogen as a combustion gas is already described in DE 10 2020 126 276 B3.

### SUMMARY

An aspect of the present invention is therefore to provide a furnace body for a drum roaster, a drum roaster, and an associated method that make possible the use of alternative energy sources in a simple and cost-effective manner.

In an embodiment, the present invention provides a furnace body for a drum roaster. The drum roaster is a part of a combustion arrangement. The combustion arrangement is for a combustion gas for heating a supply air. At least one combustion flame is guided in the combustion arrangement. A hydrogen-air mixture is provided as the combustion gas. The furnace body comprises a hollow cylinder arrangement which is arranged to enclose a combustion chamber. The hollow cylinder arrangement comprises a first base surface, a second base surface, and at least one single-walled hollow cylinder. The second base surface is open so as to discharge a heating air. The combustion arrangement is arranged in the hollow cylinder arrangement. The combustion arrangement comprises a burner pad and an ignition device. A combustion gas supply is fluidically connected to the first base surface

### BRIEF DESCRIPTION OF THE DRAWINGS

The present invention is described in greater detail below on the basis of embodiments and of the drawings in which:

FIG. 1 shows a partially sectioned side view of a drum roaster according to the present invention;

FIG. 2 shows a partially sectioned side view of a furnace body of the drum roaster shown in FIG. 1; and

FIG. 3 shows a plan view of the furnace body shown in FIG. 2.

### DETAILED DESCRIPTION

The present invention provides a furnace body in which a hydrogen-air mixture is provided as the combustion gas, wherein a hollow cylinder arrangement is provided which comprises at least one single-walled hollow cylinder which encloses a combustion chamber and in which a burner pad and an ignition device are arranged as a combustion arrangement and whose first base surface is fluidically connected to a combustion gas supply and whose second base surface is open to discharge the heating air. This provides a very compact and safe combustion arrangement integrated in the furnace body. The furnace body is also configured as a single-walled structure and is therefore much simpler than conventional furnace bodies, which also comprise a flame tube.

The diameter-length ratio D_{Hz}/L_{Hz} of the diameter to the length of the hollow cylinder can, for example, be between 0.5 and 0.9. This provides a particularly efficient heating air generation. The hollow cylinder comprises a connection flange with a reduced diameter for connection to the combustion gas supply, thereby creating a venturi effect that results in a particularly favorable mixing of the drawn-in atmospheric supply air with the hydrogen-air mixture. The connection flange can, for example, at least partially accommodate the burner pad and the ignition device. The connection flange can in this case have a diameter D_{Af} that is, for example, between 0.6×D_{Hz} and 0.9×D_{Hz} of the diameter D_{Hz} of the hollow cylinder.

In order to produce a particularly even distribution of the heating air, the hollow cylinder arrangement comprises a baffle wall arrangement in its upper half, as viewed in the flow direction of the heating air. The baffle wall arrangement can in this case, for example, comprise a baffle wall disc and a baffle wall ring which are connected to one another by bar elements. Due to the fact that the baffle wall disc, as viewed in the direction of flow of the heating air, is provided at a first, lower height level and the baffle wall ring is provided at a second, higher height level, the heating air that is generated is first guided outwards in the direction of an inner wall of the hollow cylinder and then guided back to the center of the hollow cylinder by the baffle wall ring.

In order to supply air in a simple manner, a supply air disc is provided in the lower region of the hollow cylinder arrangement. The supply air disc can in this case enclose the connection flange and be connected to the connection flange fluidically, wherein a shell surface of the supply air disc comprises supply air openings. This provides a furnace body that is particularly optimized in terms of packaging space.

In order to provide that the combustion chamber is insulated, the hollow cylinder can be surrounded by an insulating material. The insulating material can, for example, in this case consist of mineral wool that is laminated with aluminum. The insulating material can be connected to the air supply disc in order to provide a particularly compact furnace body.

An inspection glass and a flame sensor, for example, a UV cell, can be provided in openings of the hollow cylinder to monitor the combustion chamber. The inspection glass and the flame sensor are in this case arranged outside of the hollow cylinder and connected to the combustion chamber via angled checking cylinders. This is a simple and safe way to monitor the burner pad and the ignition device.

The present invention also provides a drum roaster in which a hydrogen-air mixture is provided as combustion gas, wherein the heating assembly comprises a combustion gas blower that generates the hydrogen-air mixture, wherein a furnace body is provided as set forth above. This makes it possible to use a hydrogen-air mixture as a combustion gas in a simple and cost-effective way. The roasting process does not require the user to make any special adjustments with regard to the conventionally known roasting process using natural gas as the energy source.

A control device can, for example, be provided, at least for the heating assembly.

The present invention also provides a method of operating a drum roaster as set forth above in which the heating air, and thus the heating power, are controlled in a simple manner by the speed of the combustion gas blower.

An embodiment of the present invention is explained in greater detail below under reference to the drawings.

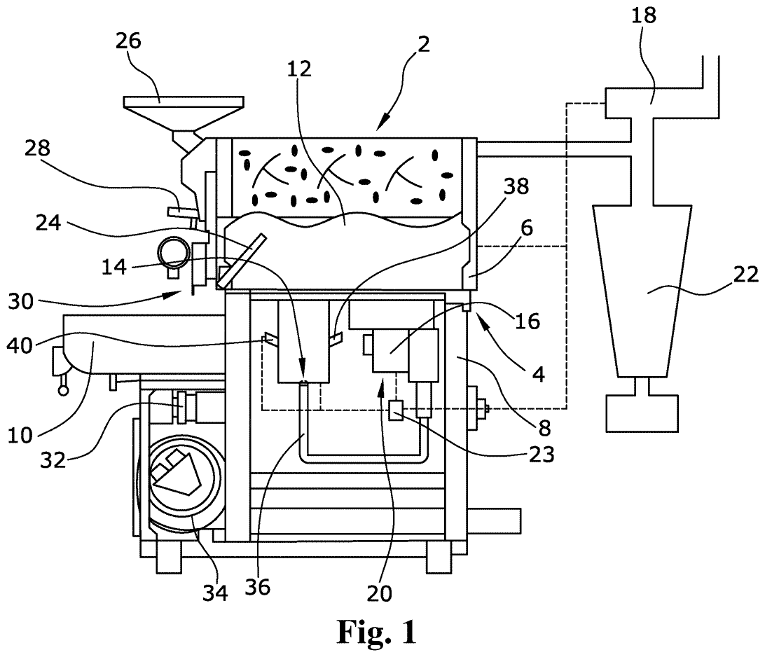

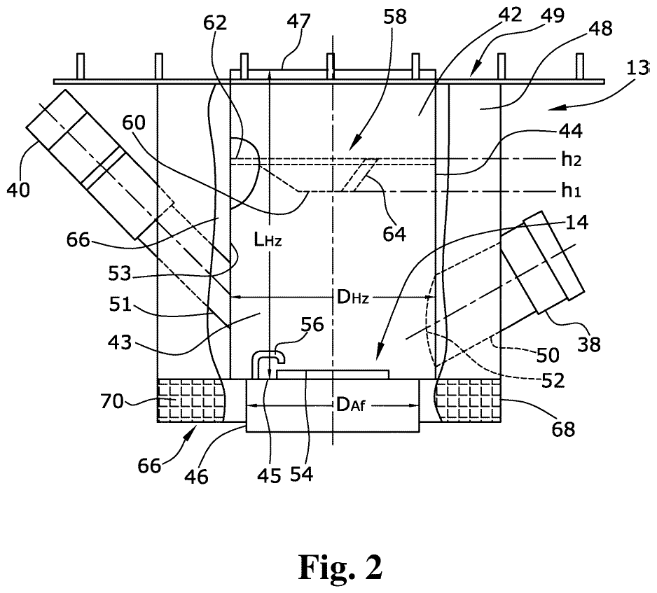

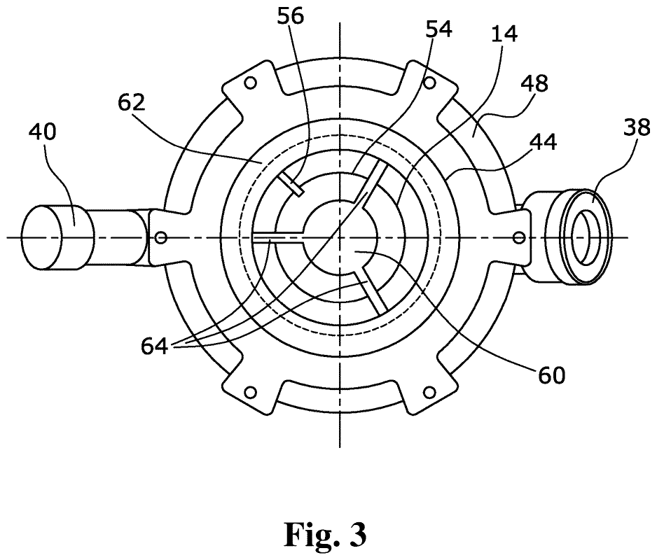

FIG. 1 shows a typical drum roaster 2 as a shop roaster. The drum roaster 2 has a housing arrangement 4 which essentially comprises a drum housing part 6 and a base housing part 8. For the sake of clarity, the base housing part 8 is shown open, i.e., without cover panels. The drum housing part 6 is placed on the base housing part 8, wherein the base housing part 8 has a collecting container 10 for roasted beans. In and on the drum housing part 6, in a manner known per se, is a roasting drum 12, which is shown here in a partially cut-away view, as well as a drive, which is not shown in further detail, for rotating the roasting drum 12, and a combustion arrangement 14 arranged in a furnace body 13 for heating the heating air located in the roasting drum 12 (see in particular also FIGS. 2 and 3). The furnace body 13 with the combustion arrangement 14, together with a combustion gas blower 16 and a suction fan 18, define a heating assembly 20 which provides the supply of supply air as heating air into the roasting drum 12 and the removal of exhaust air through a cyclone 22 known per se and controlled by a control device 23. A hydrogen-air mixture is generated by the combustion gas blower 16 as the combustion gas, wherein the combustion gas blower 16 is fluidically connected to a hydrogen source (which is not further illustrated). A display 24 arranged at the drum housing part 6 serves the user as an input and display panel.

A bean inlet funnel 26, a sample extractor arrangement 28, and a bean outlet arrangement 30, which also includes the collecting container 10, are also shown in FIG. 1. A mixing drive device 32 for a mixing device, which is not further represented and is rotatably supported in the collecting container 10, and a cooling air fan 34 for supplying cooling air to the collecting container 10, are provided below the collecting container 10.

As already mentioned above, the combustion gas blower 16 is provided for generating the combustion gas which, viewed in the direction of flow of the heating air, is arranged upstream of the combustion arrangement 14 and is fluidically connected to the furnace body 13 via a combustion gas supply 36.

As indicated only schematically in FIG. 1, an inspection glass 38 and a flame sensor 40, which is configured here as a UV cell, are provided in the furnace body 13 for monitoring the combustion arrangement 14. The heating air is essentially regulated by the speed of the combustion gas blower 16 via the control device 23. In the present embodiment, the control device 23 is also connected via control technology to the suction fan 18, a temperature sensor (not shown in more detail) for determining a roasting temperature in the roasting drum 12, the combustion arrangement 14, and the flame sensor 40.

FIG. 2 shows a side view of the furnace body 13. The furnace body 13 comprises a hollow cylinder arrangement 42. The hollow cylinder arrangement 42 in the present embodiment comprises a single-walled hollow cylinder 44 which encloses a combustion chamber 43, with a connection flange 46 of reduced diameter D_{Af} adjoining its first base surface 45 for connection to the combustion gas supply 36. On the opposite side, the second base surface 47 of the hollow cylinder 44 is open to make it possible to discharge the heating air generated in the drum housing part 6. The heat transfer to the beans takes place through direct contact with the heating air by convection and through the roasting drum 12 by conduction. A diameter-length ratio D_{Hz}/L_{Hz} of the diameter to the length of the hollow cylinder 44 is 0.72 in the present embodiment. The diameter D_{Af} of the connection flange 46 is 0.86×D_{Hz} of the diameter of the hollow cylinder 44. The hollow cylinder 44 is surrounded by an insulating material 48 consisting of aluminum-backed mineral wool (see FIG. 2).

A two-part flange element 49 is used to make the connection to the drum housing possible. The inspection glass 38 and the flame sensor 40 are arranged outside of the hollow cylinder 44 and are connected to the combustion chamber 43 by angled checking cylinders 50, 51 that extend through corresponding openings 52, 53 of the hollow cylinder 44. The angled positioning of the checking cylinders 50, 51 makes it possible to monitor the combustion arrangement 14, consisting of a burner pad 54 and an ignition device 56 (see FIG. 3). During operation, the ignition device 56 appears to be glowing red-hot and the burner pad 54 comprises embers in its normal state. The burner flame is not visible during normal operation. The hollow cylinder 44 comprises a connection flange 46 with a reduced diameter for connection to the combustion gas supply 36, thereby creating a venturi effect, which causes the intake of atmospheric supply air to be mixed with the hydrogen-air mixture.

In order to provide an optimal distribution of the heating air in the combustion chamber 43, the hollow cylinder arrangement 42 comprises a baffle wall arrangement 58 in its upper half, as viewed in the flow direction of the heating air. The baffle wall arrangement 58 consists of a baffle wall disc 60 and a baffle wall ring 62, which are connected to one another by bar elements 64. The baffle wall disc 60 is arranged at a first, lower height level h1, as seen in the direction of flow of the heating air, and the baffle wall ring 62 is arranged at a second, higher height level h2. As a result, the heating air is first directed outwards to an inner wall 65 of the hollow cylinder 44 and then back to the center through the baffle wall ring 62, subsequently leaving the combustion chamber 43 via the open second base surface 47.

A supply air disc 66 is provided in the lower region of the hollow cylinder arrangement 42 for supplying atmospheric supply air, which surrounds the connection flange 46 and is fluidically connected to the connection flange 46 wherein a shell surface 68 of the supply air disc 66 comprises supply air openings 70 through which the atmospheric supply air passes into the combustion chamber 43 and to the burner pad 54. The insulating material 48 in the present embodiment is connected to the supply air disc 66.

FIG. 3 shows a plan view of the furnace body 13 of FIG. 2, wherein only a part of the flange element is visible, in particular the baffle wall arrangement 58 and the combustion arrangement 14.

The present invention is not limited to embodiments described herein; reference should be had to the appended claims.

### LIST OF REFERENCE NUMERALS

2 Drum roaster
4 Housing arrangement
6 Drum housing part
8 Base housing part
10 Collecting container
12 Roasting drum
13 Furnace body
14 Combustion arrangement
16 Combustion gas blower
18 Suction fan
20 Heating assembly
22 Cyclone
23 Control device
24 Display
26 Bean inlet funnel
28 Sample extractor arrangement
30 Bean outlet arrangement
32 Mixing drive device
34 Cooling air fan
36 Combustion gas supply
38 Inspection glass
40 Flame sensor
42 Hollow cylinder arrangement
43 Combustion chamber
44 Hollow cylinder
45 First base surface
46 Connection flange
47 Second base surface
48 Insulating material
49 Two-part flange element
50 Checking cylinder
51 Checking cylinder
52 Opening
53 Opening
54 Burner pad
56 Ignition device
58 Baffle wall arrangement
60 Baffle wall disc
62 Baffle wall ring
64 Bar element
66 Supply air disc
68 Shell surface
70 Supply air opening
D_{Af} Diameter of connection flange 46
D_{Hz} Diameter of hollow cylinder 44
h₁ First, lower height level
h₂ Second, higher height level
L_{Hz} Length of the hollow cylinder 44

What is claimed is:

1-16. (canceled)

17. A furnace body for a drum roaster, wherein,
the drum roaster is a part of a combustion arrangement,
the combustion arrangement is for a combustion gas for heating a supply air,
at least one combustion flame is guided in the combustion arrangement, and
a hydrogen-air mixture is provided as the combustion gas,
the furnace body comprising:
a hollow cylinder arrangement which is arranged to enclose a combustion chamber, the hollow cylinder arrangement comprising a first base surface, a second base surface, and at least one single-walled hollow cylinder, the second base surface being open so as to discharge a heating air;
the combustion arrangement is arranged in the hollow cylinder arrangement, the combustion arrangement comprising a burner pad and an ignition device; and
a combustion gas supply which is fluidically connected to the first base surface.

18. The furnace body as recited in claim 17, wherein a diameter-length ratio of a diameter of the at least one single-walled hollow cylinder to a length of the at least one single-walled hollow cylinder is between 0.5 and 0.9.

19. The furnace body as recited in claim 17, wherein the at least one single-walled hollow cylinder comprises a connection flange comprising a reduced diameter, the connection flange being configured to connect to the combustion gas supply.

20. The furnace body as recited in claim 19, wherein the connection flange is arranged to at least partially accommodate the burner pad and the ignition device.

21. The furnace body as recited in claim 19, wherein the connection flange further comprises a diameter which is between 0.6 and 0.9 of a diameter of the at least one single-walled hollow cylinder.

22. The furnace body as recited in claim 19, further comprising:
a supply air disc which is arranged in a lower region of the hollow cylinder arrangement.

23. The furnace body as recited in claim 22, wherein,
the supply air disc is arranged to enclose the connection flange and to be fluidically connected to the connection flange, and
the supply air disc comprises a shell surface which comprises supply air openings.

24. The furnace body as recited in claim 17, wherein the hollow cylinder arrangement further comprises a baffle wall arrangement which is arranged in an upper half of the hollow cylinder arrangement as viewed in a flow direction of the heating air.

25. The furnace body as recited in claim 24, wherein the baffle wall arrangement comprises a baffle wall disc and a baffle wall ring which are connected to one another via bar elements.

26. The furnace body as recited in claim 25, wherein the baffle wall disc is arranged at a first, lower height level and the baffle wall ring is arranged at a second, higher height level, as viewed in the flow direction of the heating air

27. The furnace body as recited in claim 17, further comprising:
an insulating material which is arranged to enclose the at least one single-walled hollow cylinder.

28. The furnace body as recited in claim 17, wherein,
the at least one single-walled hollow cylinder further comprises openings, and
an inspection glass and a flame sensor are arranged in a respective one of the openings of the at least one single-walled hollow cylinder.

29. The furnace body as recited in claim 28, wherein,
the inspection glass is arranged outside of the at least one single-walled hollow cylinder and is connected to the combustion chamber via a first angled checking cylinder, and
the flame sensor is arranged outside of the at least one single-walled hollow cylinder and is connected to the combustion chamber via a second angled checking cylinder.

30. A drum roaster for roasting beans, the drum roaster comprising:
a housing assembly in which a roasting drum for receiving the beans is rotatably supported;
a drive which is configured to rotate the roasting drum; and
a heating assembly which is configured to heat the beans at least via a heating air, the heating assembly comprising:
a furnace body as recited in claim 17, the furnace body being configured to have at least one combustion flame be guided therein,
at least one combustion arrangement for a combustion gas for heating a supply air, the at least one combustion arrangement being arranged in the furnace body upstream of the roasting drum as viewed in a flow direction of the heating air,
at least one suction fan which is arranged downstream of the roasting drum as viewed in the flow direction of the heating air, the at least one suction fan being configured to extract the heating air from the roasting drum, and
a combustion gas blower,
wherein,
a hydrogen-air mixture is provided as the combustion gas, and
the combustion gas blower is configured to generate the hydrogen-air mixture.

31. The drum roaster as recited in claim 30, further comprising:
a control device which is configured to control at least the heating assembly.

32. A method of operating the drum roaster as recited in claim 31, the method comprising:
controlling the heating air via a speed of the combustion gas blower.
